(19) United States
(12) Patent Application Publication
(10) Pub. No.: US 2004/0173919 A1
(43) Pub. Date: Sep. 9, 2004

(54) Strip for packing module, corresponding module and installation

(76) Inventors: Etienne Werlen, Paris (FR); Patrick Le Bot, Vincennes (FR); Jean-Yves Lehman, Maisons Alfort (FR)

Correspondence Address: Air Liquide, Intellectual Property Department, Suite 1800, 2700 Post Oak Road, Houston, TX, 77056, US

(21) Appl. No.: 10/482,831

(22) PCT Filed: Jun. 27, 2002
(86) PCT No.: PCT/FR02/02226

(30) Foreign Application Priority Data
Jul. 6, 2001 (FR) 01/0921
Jul. 6, 2001 (FR) 01/09023

(51) Int. Cl. B01F 3/04

(52) U.S. Cl. 261/94; 261/112.2

(57) ABSTRACT

The invention relates to a strip, made from a sheet material, for a packing module for treatment of liquids, comprising corrugations, which are mainly oriented at an inclination to the direction of flow of said liquid, when the strip is in an approximately vertical plane with the edges thereof approximately horizontal. The strip comprises openings (44) with extended edges. The direction of the edges on the lower section of the openings and the natural direction of flow (S) of the liquid on at least 75% of the length of the edges of said lower section form an included angle of between 0° and 20°. The above finds application in air distillation columns.

The present invention relates to a strip of material in sheet form, particularly in sheet metal, for a packing module for treating a liquid, of the type comprising corrugations, when the strip is arranged in a vertical overall plane with its edges horizontal, have an overall orientation inclined with respect to an overall direction of flow of said liquid, that is substantially vertical, and comprising openings of elongate overall shape having edges stretching in the general direction of the opening.

Packing is to be understood as meaning a device intended for the mixing of a phase and/or for the bringing into contact of several phases circulating cocurrent or countercurrent with respect to each other. In particular, an exchange of heat and/or matter and/or chemical reaction may occur within the packing. One particular application of the invention lies in columns used to separate gaseous mixtures, particularly air distillation columns.

Known from the prior art are air distillation installations comprising modules, also known as packs, of cross-corrugated packing. The modules comprise corrugated sheets arranged vertically, the corrugations of which sheets are oblique with respect to an overall direction of flow of fluid through the installation, and inclined alternately, generally crossed at 90°, from one sheet to the next.

The packing modules are slipped into the distillation column in such a way that the sheets of one module are angularly offset from the sheets of an adjacent module about the axis of the column, generally by 90° from one module to the next.

In order to improve the exchange between a liquid and a gas flowing through the packing module, the prior art has proposed openings formed in the sheets. These openings lead to a change in the flow of the gas from one side of the packing sheet to the other and improve the exchange with the liquid.

These openings come in two categories:

Firstly, openings which are small enough that they can be filled with a continuous film of liquid or that the liquid can run around them without creating a dry zone downstream. Packings comprising such openings are disclosed for example in documents CA-A-1 095827, U.S. Pat. No. 4,740,334, EP-A-0 158 917, U.S. Pat. No. 4 604 247, EP-A-0 218 417 and U.S. Pat. No. 5,057,250.

Secondly, large-sized openings that encourage turbulence in the gas but impede the flow of liquid and create dry zones downstream. Packings comprising such openings are disclosed for example in documents EP-A-0 750 940, U.S. Pat. No. 4,670,196, U.S. Pat. No. 5,407,607, U.S. Pat. No. 5,578,254, U.S. Pat. No. 5,885,69 and EP-A-1 029 588.

It is an object of the invention to propose packings that allow improved exchange between the liquid and the gas.

To this end, the subject of the invention is a strip of the aforesaid type, characterized in that the openings comprise, starting from their lowermost point, a lower region the edges of which, over at least 75% of their total length, run in a direction which makes, with the natural direction of flow of the liquid at each corresponding point, an angle of between 0° and 20°, particularly between 0° and 10°.

According to some particular embodiments, the strip may have one or more of the following features:

the edges of said lower region run over at least 90% of their total length in a direction which makes said angle of between 0° and 20° , particularly between 0° and 10°;

the edges of said lower region run over their total length in a direction which makes said angle of between 0° and 20°, particularly between 0° and 10°;

the edges of the entire periphery of the openings run in a direction which makes said angle of between 0° and 20°, particularly between 0° and 10°;

the openings are triangles of which the vertex formed by the two longest sides faces more or less in the direction of natural flow of the liquid;

said openings have dimensions such that they avoid coverage by a film of said liquid;

the direction of the edges of said openings, at least in said lower region, is more or less parallel to the direction of natural flow of the liquid over the surface of the strip near the edges of the opening;

the strip comprises smooth surfaces so that the direction of natural flow of the liquid is, over these surfaces, the direction of greatest slope of the strip;

the distance (p′) between two crest (36) or trough (38) lines of the partial strips (34), as measured in the direction of the edge (40) of the strip (24), is identical over the entire surface of a running region (28) of the strip, and in that the strip is, an identical replica of itself when shifted in the direction of the edge by a distance N×p′, with and preferably 4>N≧1.

the strip comprises, in its running region, openings arranged at a distance that is a sub-multiple of said distance, particularly half this distance, in the direction of the horizontal edge of the strip;

the fold angle of the corrugations of the partial strips, the height of these corrugations, the radius of curvature and the inclination of these corrugations with respect to the horizontal edge are identical over the entire surface of the strip;

the strip comprises adjacent corrugated first and second partial strips that are offset from one another, particularly by half a corrugation pitch,

the partial strips have natural directions of flow of the liquid that differ from one another;

the edges of said openings of the partial strips run in a direction that is intermediate between said directions of natural flow of the liquid, particularly roughly parallel to the bisector of the two directions;

the said openings consist of flaps bent out of the plane of the strip, which flaps are defined by a curved slot made in the strip;

said openings consist of bosses made on one side of a slot, particularly in the form of a partial cone or in the form of a partial cylinder;

said openings consist of twisted parts running between two parallel slots;

said openings consist of reentrant folds which run on one side of a slot passing through the crest of a fold of the strip;

said openings are slots passing through the crest of a fold of the strip, this being so as to avoid the liquid concentrating in the bottoms of the corrugations;

the strip comprises, at least at one of its upper or lower regions, means for spreading liquid transversely to the main direction of flow of fluid, particularly striations or perforations made in the strip;

the packing strip has none of said openings in said upper and/or lower region; and

the strip comprises, in its upper and/or lower region, headloss reduction means.

Another subject of the invention is a packing module for a matter and/or heat exchange column, characterized in that it comprises a stack of strips as defined hereinabove, with their directions of corrugation reversed from one strip to the next.

A further subject of the invention is an installation for the exchange of matter and/or heat comprising at least one packing module as defined hereinabove and a device for distributing liquid over the upper surface of the module.

According to one particular embodiment of this installation, the liquid distributing device comprises a distributor and/or a packing module that encourages the liquid to spread transversely with respect to the main direction of flow.

The invention will be better understood from reading the description which will follow, given solely by way of example and made with reference to the attached drawings, in which:

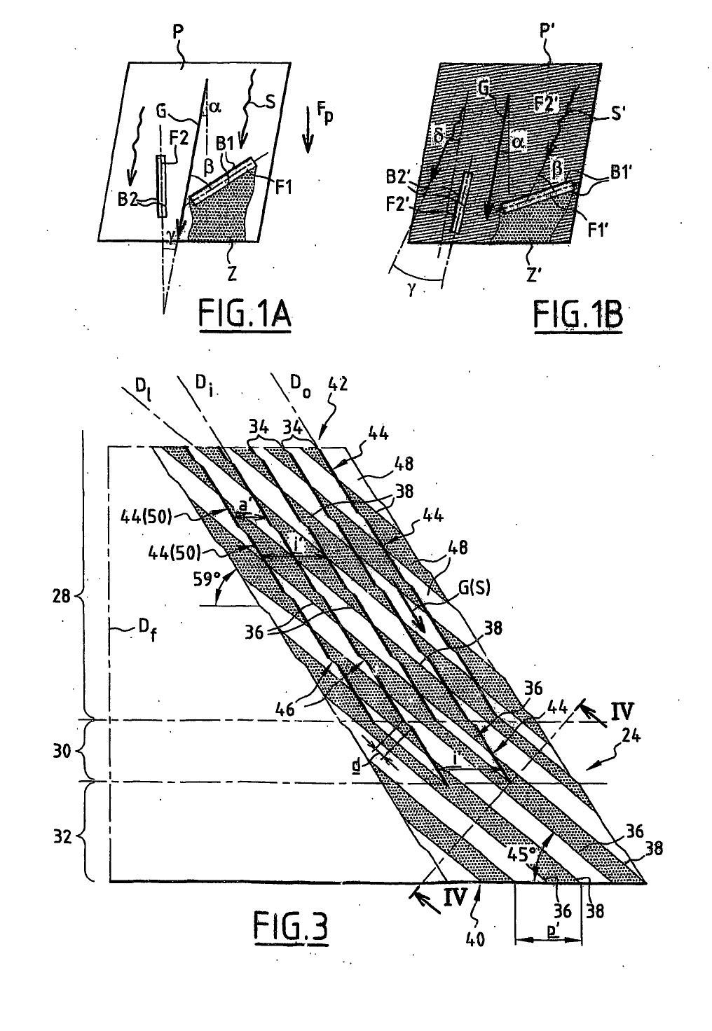

FIGS. 1A and 1B depict slotted plates inclined and supplied with liquid;

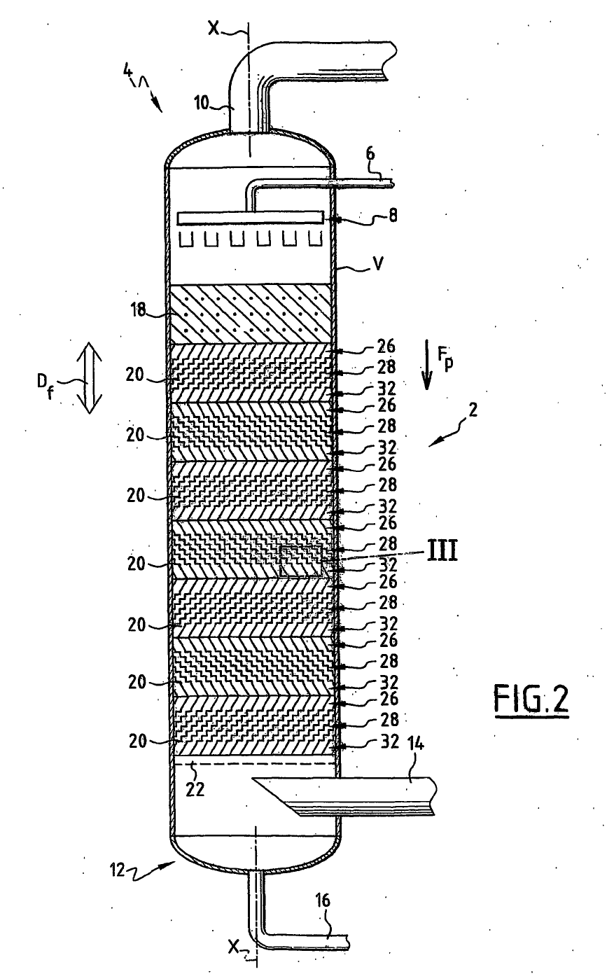

FIG. 2 is a schematic view in longitudinal section of a column for the exchange of matter and/or heat, comprising packing modules according to the invention;

FIG. 3 is detail III of FIG. 2, on a larger scale;

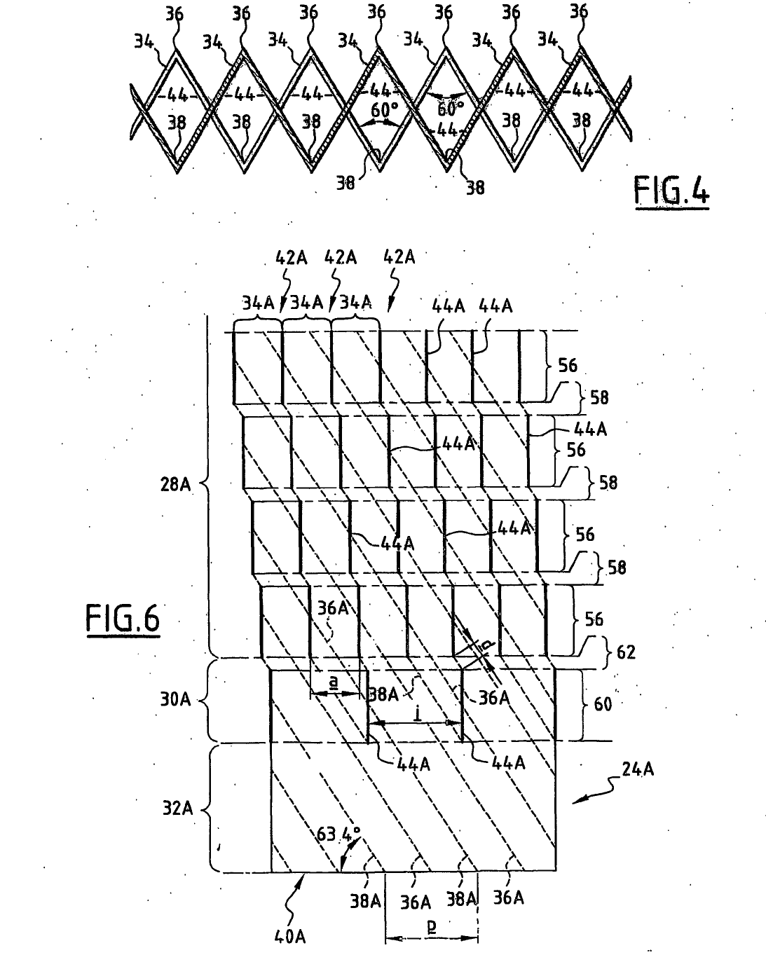

FIG. 4 is a view in section on IV-IV of FIG. 3;

FIG. 5 is a perspective view of the detail depicted in FIG. 3;

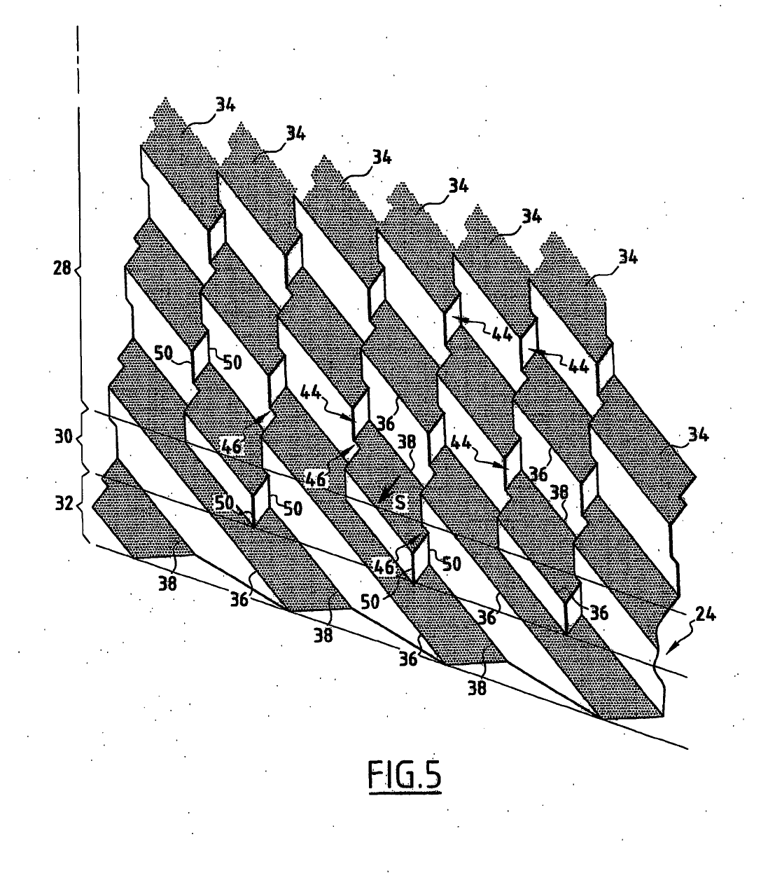

FIG. 6 is a plan view of a blank used to manufacture the part of the packing strip of FIG. 3;

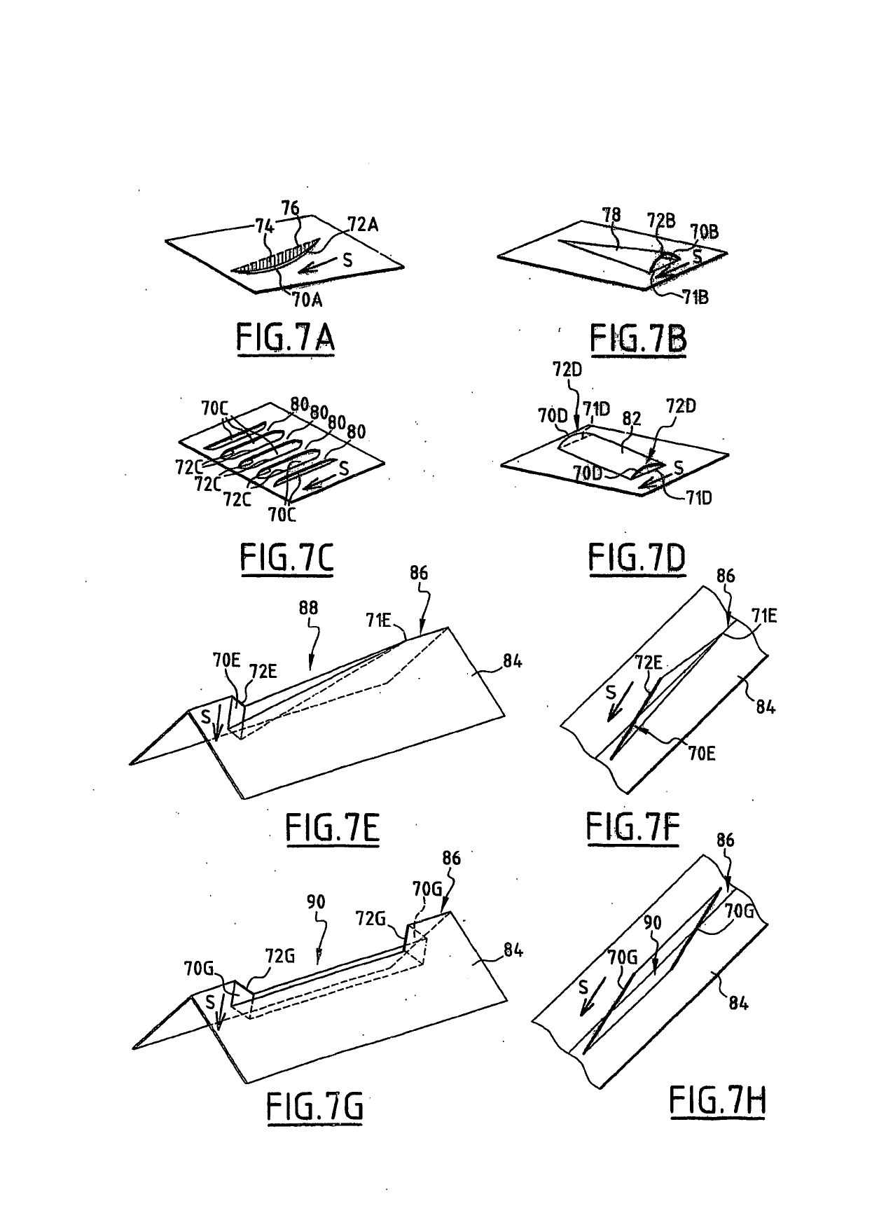

FIGS. 7A to 7H depict perspective or side views of alternative forms of opening made in packing strips according to the invention;

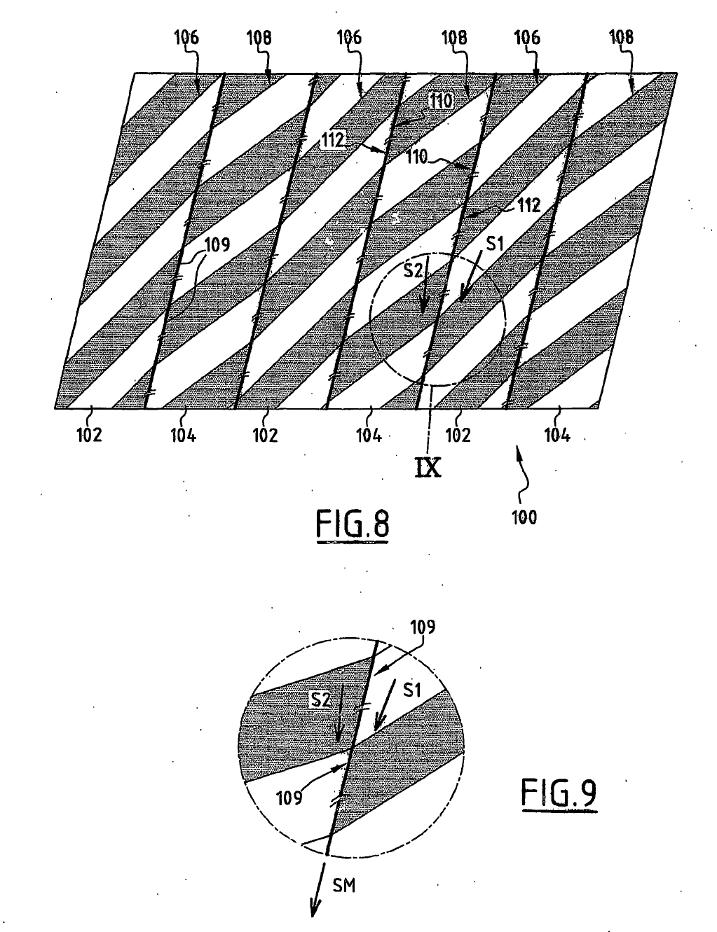

FIG. 8 is a side view of an alternative form of a packing strip according to the invention; and

FIG. 9 is detail IX of FIG. 8, on a larger scale.

First of all, the problem underlying the invention and the principle of its solution will be explained using FIGS. 1A and 1B.

FIG. 1A depicts a smooth plate P inclined by an angle a with respect to the vertical (force of gravity Fₚ). A liquid flows over the upper surface of the plate.

The plate P has a direction of greatest slope G defined by the cross section of the surface of the plate with a vertical plane perpendicular to this surface. When the plate P is supplied with liquid, the liquid flows in a natural direction S of flow, which coincides in the case of this smooth-surfaced plate P, with the direction of greatest slope G.

Two rectangular slots F1 and F2 are made in the plate P. The respective longitudinal edges B1 and B2 of the slots F1 and F2 define angles β and γ respectively with the direction of greatest slope G. The angle β is greater than an angle of separation of the liquid with the edge of a slot, while the angle γ is smaller there than.

The angle of separation of the liquid depends on the viscosity of the liquid and on the material of the plate.

Because the angle β is greater than the angle of separation of the liquid, the liquid drips from the edge B1 of the slot F1 and creates a dry zone Z downstream of this slot. In this zone Z an exchange of heat and/or of matter between the liquid and a gas is not possible.

By contrast, thanks to the small angle γ, that is to say the angle smaller than the angle of separation of the liquid, the liquid flows around the edges B2 of the slot F2 and covers the part of the plate situated downstream of this slot. In consequence, an exchange between a gas and some liquid takes place at this location. As a preference, the angle γ is 0°, that is to say that the edges of the slot F2 run parallel to the direction of natural flow of liquid. The angle γ may be between 0° and 20°, particularly between 0° and 10°.

FIG. 1B depicts a plate P′ arranged in the same way as the plate P. This plate P′ has striations running obliquely with respect to the horizontal. The direction S′ of natural flow of the liquid flowing over this plate P′ differs from the direction of greatest slope G of this plate P′ by an angle δ.

The flow of the liquid is deflected toward the direction of the striations. The longitudinal edges B1′ of the slot F1′ also form an angle β with the direction of natural flow of the liquid S′. In consequence, a dry zone Z′ is created downstream of the slot F1′.

The slot F2′ and its longitudinal edges B2′ run at an angle γ with respect to the direction S′ of natural flow of the liquid. This slot F2′ therefore does not create a dry zone downstream of the flow of liquid.

FIG. 2 depicts a column for the exchange of matter and/or heat 2 according to the invention, with an overall vertical axis X-X. The column 2 comprises, at its upper end 4, a liquid inlet 6, opening into a distributor 8 which distributes liquid over the cross section of the column 2, and a vapor outlet 10. At its lower end 12, it comprises a vapor inlet 14 and a liquid outlet 16. The column 2 also comprises a cylindrical column shell.

A packing module 18 that encourages the liquid to spread transversely to the axis X-X is arranged in the column shell V directly under the distributor 8. Such a module 18 is known per se and is, for example, a packing module comprising a cross-corrugated packing with perforations or striations.

A plurality of packing modules 20 according to the invention is arranged in the column shell V under the module 18. A lower support 22 holds the packing modules 18, 20. Each packing module 20 comprises a multiplicity of corrugated packing strips 24. The strips 24 are each arranged parallel to an overall direction D_{f} of flow of fluid in the column 2, namely vertically, and one against the next. Each strip 24 comprises regions running horizontally, one above the next, these regions being an upper region 26, an upper transition region, a running region 28, a lower transition region 30 and a lower region 32. FIG. 3 depicts part of a packing strip 24 viewed from the side, namely part of the running region 28, the lower region 32 and the lower transition region 30.

The running region 28, viewed from the side, consists of a succession of partial strips 34 of a general direction D₁ inclined with respect to the vertical (D_{f})

Each partial strip 34 consists of flat surfaces connected alternately by crest lines 36 and trough lines 38. The lines 36, 38 have the same inclination D₁ which in this instance is roughly 45° to the lower edge 40 of the packing strip 24. The crest lines 36/trough lines 38 of one partial strip 34 extend the trough lines 38/crest lines 36 of the two adjacent partial strips 34.

Two partial strips 34 are separated by a row 42 of openings 44, straight when viewed from the side. Each opening 44 intersects the junction between a crest line 36 of a partial strip 34 and the trough line 38 of the adjacent partial strip 34. The openings 44 of one and the same row 42 are offset from one opening 44 to the next, in the direction D₁, by a short distance d, defining crosslinks 46 or linking lines linking two adjacent partial strips 34.

In the horizontal direction, the openings 44 are arranged parallel to one another at a distance a′. This distance a′ is, when measured in the direction of the horizontal edge 40 of the strip, half the distance p′ between two successive crest lines 36.

Thus, when viewed from the side, each partial strip 34 of the running region 28 exhibits a succession of approximate diamond shapes 48 inclined alternately toward the front and toward the rear of the plane of FIG. 3.

Two successive approximate diamonds 48 form an angle of 60° between them, viewed end on (see FIG. 4).

This inclination is reversed from one partial strip 34 to the adjacent partial strips, in the direction D₁.

The lower transition region 30 comprises openings 44 identical to those of the running region 28. The difference is that the openings 44 are spaced a distance i apart, in the horizontal direction, which distance is twice the distance a′ separating the openings 44 of the running region 28. In other words, every second opening 44 is omitted.

The lower region 32 and the upper region 26 consist of a corrugated part of the packing strip devoid of openings. The surface of this region consists of continuations of the surfaces of the diamonds 48 of the transition regions.

When the packing module 20 is in the mounted state, the packing strips 24 are arranged one against the other in such a way that the trough lines 38 and crest lines 36 of one strip are offset by roughly 90° with respect to those of an adjacent strip 24, that is to say that their directions D₁ are inclined by about 45° in one direction and the other with respect to the direction D_{f} from one strip 24 to the next.

The edges 50 of each opening 44 run, when viewed from the side, in a direction D₀ inclined at 59° to the horizontal, which corresponds, for an angle of 60° between two approximate diamonds 48 and for a direction at 45° of the crest lines/trough lines of a smooth strip 24, to the direction S of natural flow of liquid, and therefore, for the example given, to the direction of greatest slope G of FIG. 1A.

Liquid which flows over the surface of the strip 24 therefore flows roughly parallel to the edges 50 of the openings 44. In consequence, the creation of dry zones downstream of the openings 44 as the liquid flows is greatly reduced, or avoided. The modules 20 according to the invention therefore have a large effective gas/liquid exchange area. Each opening 40 leads to sectioning of the flow of gas and to the creation of turbulence, increasing the exchange efficiency of the packing. In addition, each opening 44 has a large size, which means that it leads to a small headloss.

In general, the direction of the edges needs to be close enough to the direction S of natural flow of the liquid to avoid liquid dripping from the edges. The possible inclination is generally between 0° and 20° with respect to the direction of natural flow of liquid.

In the case of the strip 24, the inclination with respect to the vertical of the surfaces is identical at each point on the packing strip 24. In consequence, the direction S of natural flow of liquid is also identical at every point on the strip 24. In general, when the strip has parts that are not flat (for example folds with rounded section), the edges of the openings have to run in such a way that at every point on the edge of the opening the direction of the tangent to the edge at that point is close to the direction S of natural flow of the liquid at that point on the strip, or preferably identical to that direction.

The strip 24 is manufactured from sheet metal from a flat blank 24A.

FIG. 6 depicts part of this blank. This part is used for the manufacture of the part of the strip 24 of FIG. 3. The references of the blank correspond to the references of the corresponding parts of the packing strip 34, with an added A.

This blank is made of thin, smooth and flat sheet metal.

The blank 24A comprises a running region 28A, comprising columns 42A of slots 44A. Each slot 44A is a straight slot arranged at right angles to the lower edge 40A of the blank 24A. Each slot 44A runs from a zone situated midway between two future crest 36A and trough 38A lines (indicated in dotted line in FIG. 6) across one of these future lines 36A, 38A into a zone situated midway between the future trough 38A/crest 36A lines. The slots 44A of one vertical row 42A are offset from one to the next, in the direction of these future crest lines 36A or trough lines 38A, by the aforementioned distance d.

The slots 44A of one row 42A are arranged, relative to the slots 44A of the adjacent row 42A, at a distance a which corresponds to half the distance p between two future crest 36A (or trough 38A) lines measured along the edge 40A. Furthermore, the slots 44A of two adjacent rows 42A are arranged at identical distances with respect to the edge of the flat. In other words, the slots 44A of the blank constitute horizontal rows 56 parallel to the edge 40A. Two rows 56 are separated by a connecting zone 58 that is devoid of slots 44A.

The blank 24A further comprises a transition region 30A which comprises a horizontal row 60 of slots. In this region, one slot 44A in two is omitted. The lower row 56 of the running region 28A and the row 60 are separated by a connecting zone 62 devoid of slots, similar to the connecting zones 58.

The blank 24A further comprises a solid lower region 32A which is smooth and flat and corresponds to the lower region 32 of the packing strip.

In consequence, the pitch of the slots 44A of the running region 28A of the blank is identical to the distance of future crest 36A/trough 38A lines, p, and the cutting and bending tool used to manufacture the strip 24 can be particularly simple. In general, the slots 44A are arranged at a distance corresponding to a low integer multiple N of the distance between the crest lines, for example ranging as high as 4.

The manufacture of, the packing strip from the slotted blank 24A is performed by folding at a fold angle of 60°, with the strip advancing in successive steps, using bending rods of suitable configuration. Because of this bending, the slots 44A open out accordingly, and form the openings 44 (see FIGS. 4 and 5).

Through this bending at 60°, the crest/trough lines place themselves at an angle of 45° with respect to the horizontal.

FIGS. 7A to 7H depict various alternative forms of openings 70A to 70G formed in a packing strip according to the invention.

In each of FIGS. 7A to 7H, the arrow S indicates the direction of natural flow of the liquid, and the edges 72A to 72E, 72G of the openings 70A to 70E, 70G run roughly parallel thereto, within the meaning explained above.

FIG. 7A shows a flap 74, made from a slightly curved slot, particularly one curved into the arc of a circle, and pushed back outside of the plane of the strip along a chord 76 roughly parallel to the direction of natural flow S of the liquid.

FIG. 7B shows an opening 70B formed by a boss 78 pressed in the form of a partial cone on one side of a straight slot 71B roughly parallel to the direction S.

FIG. 7C shows five parallel openings 70C of identical length, roughly parallel to the direction S, formed in the packing strip. The four zones running between the openings are twisted about an axis parallel to the openings, to form louvers 80.

FIG. 7D depicts two openings 70D formed of two parallel slots 71D of identical length, roughly parallel to the direction S, between which there runs a pressed boss 82 of partially cylindrical shape.

FIGS. 7E and 7F show a bent part 84 of a packing strip. A slot is formed obliquely through the crest 86 of the fold and the strip comprises, on one side of the slot, a reentrant fold 88 forming an opening 70E. The reentrant fold 88 has a decreasing depth and extends as far as a point 71E distant from the opening 70E.

The part of the packing strip depicted in FIGS. 7G and 7H corresponds essentially to that of FIGS. 7E and 7F. The difference is that this part comprises two openings 70G made from two parallel oblique slots of identical length. The part 90 of the strip lying between the two slots forms a reentrant fold of constant depth.

FIG. 8 depicts an alternative form of a packing strip according to the invention. This packing strip 100 consists of alternating corrugated and parallel first and second partial strips 102, 104, with different corrugation pitches, measured along the edge of the strip. The corrugations 106, 108 of the strips 102, 104 are inclined with respect to the horizontal, when the strip is in the mounted state, at different angles. In consequence, the first partial strips 102 have a direction of natural flow of liquid S1 that differs from the direction of natural flow of liquid S2 of the second partial strips 104 (FIG. 9). The corrugation of one partial strip 102, 104 is offset by half a notch from an adjacent partial strip 104, 102 so that the troughs of one partial strip 102, 104 lie facing the crests of an adjacent partial strip 104, 102. The partial strips 102, 104 form openings 109 between them.

The edges 110, 112 of the partial strips 102, 104 are straight and arranged parallel to the mean direction SM of the directions S1 and S2 of natural flow of liquid of the first and second partial strips 102, 104. This mean direction of flow SM is somewhere between the two directions S1, S2 of flow and is preferably identical to the bisector of these two directions.

This packing strip 100 increases the turbulence of the gas and therefore the efficiency of the exchange between the gas and the liquid while at the same time almost completely avoiding the creation of dry zones.

The strip 100 may be produced by welding the partial strips together, or by cutting and folding a solid blank using two sets of bending rods.

As an alternative, a packing module that comprises a packing strip according to the invention may comprise, at its upper and/or lower part, means of spreading the liquid transversely to the overall direction of flow. These spreading means may be formed by striations or perforations made in the corresponding part of the strip (such as the upper 26 or lower 30 regions of the strip 24), this part in this example being devoid of the openings such as 52, 54 of the running region 28 of the strip.

It may be observed that the packings according to the invention result in a large area for contact between the liquid and the gas, while at the same time allowing turbulence and sectioning of the flow of gas and practically avoiding any creation of dry zones.

The columns fitted with the packings according to the invention have a low packing volume and a low cost, for a given treatment throughput.

In general, at least 75% of the lower region of the openings runs at an angle γ of between 0° and 20° to the direction of natural flow of the liquid. The larger the proportion of the edges running at the angle γ the more the creation of dry zones is avoided. Thus, the lower region comprises, for example, 90% or 100% of the edges running at this angle γ.

The lower region may for example be in the shape of a triangle, of which the vertex formed by the two longest sides faces in the direction of natural flow of the liquid.

As an alternative, the lower region 32 and/or the upper region 26 may be equipped with means for reducing the headloss on the part adjacent to the next packing module.

Such means are, for example, folds comprising crests/troughs with an inclination that changes gradually from the inclination of the running region to the vertical direction toward the corresponding lower or upper edge.

1. A strip of material in sheet form, particularly in sheet metal, for a packing module for treating a liquid, of the type comprising corrugations, when the strip is arranged in a vertical overall plane with its edges horizontal, have an overall orientation (D₁) inclined with respect to an overall direction (D_{f}) of flow of said liquid, that is substantially vertical, and comprising openings (44; 70A to 70E; 70G; 109) of elongate overall shape having edges (50; 72A to 72E; 72G; 110, 112) stretching in the general direction of the opening, characterized in that the openings comprise, starting from their lowermost point, a lower region the edges (50; 72A to 72E; 72G; 110, 112) of which, over at least 75% of their total length, run in a direction which makes, with the natural direction of flow (S) of the liquid at each corresponding point, an angle (γ) of between 0° and 20°, particularly between 0° and 10°.

2. The strip as claimed in claim 1, characterized in that the edges of said lower region run over at least 90% of their total length in a direction which makes said angle (γ) of between 0° and 20°, particularly between 0° and 10°.

3. The strip as claimed in claim 2, characterized in that the edges of said lower region run over their total length in a direction which makes said angle (γ) of between 0° and 20°, particularly between 0° and 10°.

4. The strip as claimed in claim 3, characterized in that the edges of the entire periphery of the openings run in a direction which makes said angle (γ) of between 0° and 20°, particularly between 0° and 10°.

5. The strip as claimed in claim 3 or 4, characterized in that the lower region of the openings is a triangle of which the vertex formed by the two longest sides faces more or less in the direction of natural flow of the liquid.

6. The strip as claimed in any one of claims 1 to 5, characterized in that said openings (44; 70A to 70E; 70F; 109) have dimensions such that they avoid coverage by a film of said liquid.

7. The strip as claimed in any one of claims 1 to 6, characterized in that the direction of the edges (50; 72A to 72E; 72G; 110, 112) of said openings (44; 70A to 70E; 70G; 109), at least in said lower region, is more or less parallel to the direction (S) of natural flow of the liquid over the surface of the strip (24; 100) near the edges of the opening.

8. The strip as claimed in one of claims 1 to 7, characterized in that the strip (24, 100) comprises smooth surfaces so that the direction of natural flow of the liquid is, over these surfaces, the direction (G) of greatest slope of the strip.

9. The strip as claimed in any one of claims 1 to 8, characterized in that the distance (p′) between two crest (36) or trough (38) lines of the partial strips (34), as measured in the direction of the edge (40) of the strip (24), is identical over the entire surface of a running region (28) of the strip, and in that the strip is an identical replica of itself when shifted in the direction of the edge by a distance N×p′, with and preferably 4>N≧1.

10. The strip as claimed in claim 9, characterized in that it comprises, in its running region (28), openings (44) arranged at a distance that is a sub-multiple of said distance (p′), particularly half this distance (a′), in the direction of the horizontal edge (40) of the strip.

11. The strip as claimed in any one of claims 1 to 10, characterized in that the fold angle of the corrugations of the partial strips (34), the height of these corrugations, the radius of curvature and the inclination of these corrugations with respect to the horizontal edge (38) are identical over the entire surface of the strip (24).

12. The strip as claimed in any one of claims 1 to 10, characterized in that it comprises adjacent corrugated first and second partial strips (34, 102, 104, 106, 108) that are offset from one another, particularly by half a corrugation pitch.

13. The strip as claimed in claim 12, characterized in that the partial strips (102, 104) have natural directions of flow of the liquid (S1, S2) that differ from one another.

14. The strip as claimed in claim 13, characterized in that the edges (110, 112) of said openings (109) of the partial strips (102, 104) run in a direction (SM) that is intermediate between said directions of natural flow of the liquid (S1, S2), particularly roughly parallel to the bisector of the two directions (S1, S2).

15. The strip as claimed in any one of claims 1 to 11, characterized in that the said openings (70A) consist of flaps (74) bent out of the plane of the strip, which flaps are defined by a curved slot made in the strip.

16. The strip as claimed in any one of claims 1 to 11, characterized in that said openings (70B; 70D) consist of bosses (78; 82) made on one side of a slot (71B; 71D), particularly in the form of a partial cone or in the form of a partial cylinder.

17. The strip as claimed in any one of claims 1 to 11, characterized in that said openings (70C) consist of twisted parts (80) running between two parallel slots (70C).

18. The strip as claimed in any one of claims 1 to 11, characterized in that said openings (70E; 70G) consist of reentrant folds (88; 90) which run on one side of a slot passing through the crest of a fold (86) of the strip.

19. The strip as claimed in any one of claims 1 to 11, characterized in that said openings are slots (F2, F2′) passing through the crest of a fold (36, 38) of the strip.

20. The strip as claimed in any one of the preceding claims, characterized in that it comprises, at least at one of its upper (26) or lower (32) regions, means for spreading liquid transversely to the main direction (D_{f}) of flow of fluid, particularly striations or perforations made in the strip.

21. The strip as claimed in claim 20, characterized in that the packing strip has none of said openings in said upper (26) and/or lower (32) region.

22. The strip as claimed in any one of the preceding claims, characterized in that it comprises, in its upper (26) and/or lower (32) region, headloss reduction means.

23. A packing module for a column for exchanging matter and/or heat, characterized in that it comprises a stack of strips (24) as claimed in one of the preceding claims, with their directions of corrugation reversed from one strip to the next.

24. An installation for the exchange of heat and/or matter, characterized in that it comprises at least one packing module (20) as claimed in claim 23, and a device (8, 18) for distributing liquid over the upper surface of the module.

25. The installation as claimed in claim 24, characterized in that the liquid distributing device comprises a distributor (8) and/or a packing module (18) that encourages the liquid to spread transversely with respect to the main direction (D_{f}) of flow.
